(19) United States
(12) Patent Application Publication
(10) Pub. No.: US 2007/0002368 A1
(43) Pub. Date: Jan. 4, 2007

(54) System and method for sending a stored scanned job to printers or group of printers from a multi-function peripheral device

(76) Inventor: Fatima Corona, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/171,793

(22) Filed: Jun. 30, 2005

(51) Int. Cl. G06F 3/12

(52) U.S. Cl. 358/1.15; 358/1.13

(57) ABSTRACT

A method and apparatus for printing documents on a networked system. The method includes creating at least one print job associated with a code, sending the at least one job to a print queue and separately conveying the user identification code to a printing device. This method could be accomplished either with a tag system or by direct data entry at the site of a printing device. The device then obtains and prints the at least one job associated with the user identification code from the print queue.

### BACKGROUND OF THE INVENTION

1. Field of the Invention

The invention relates to networked printing at one or more destination printers and more specifically to sending a scan job to a destination printer or a group of destination printers from a multi-function peripheral (MFP) device and having the destination printer(s) store the job until an owner retrieves the stored job from the destination printer(s).

2. Description of the Related Technology

Sending of a scanned job to a single printer from a multi-function peripheral (MFP) control panel requires a user to access server software installed on a personal computer. A user must access the server software for each destination printer in a group of printers should the user intend for the document to print on a plurality of printers. The user repeats the procedure at the server software for every destination printer. It would be desirable for the destination printer(s) to store the document so that the user may personally initiate printing when the user is at the destination printer. Such an arrangement provides the user with a certain level of security and privacy. There is no current method of sending a scanned job from an MFP to a printer or group of printers to be stored until an owner retrieves the stored job from the destination printer or group of printers.

### SUMMARY OF CERTAIN INVENTIVE ASPECTS

The systems and methods of the present invention have several features, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the features of this invention provide several advantages over traditional printer systems.

One aspect of the present invention is a method of securely printing scanned documents on a networked system. The method comprises scanning at least one print job on a multi-function peripheral device, sending the at least one print job to at least one printer, storing the at least one print job in a queue, identifying the at least one print job at the at least one printer, and printing the identified print job from the queue.

Another aspect is a method of transferring documents from a first location to a second location. The method comprises scanning at least one document at a multi-function peripheral device having document transmission capabilities, sending the scanned document to a queue, entering access information into a printer device having access to the queue, and obtaining the at least one job associated with the access information from the queue after entering the code.

Still another aspect is a system for securely printing a scanned document. The system comprises a multi-function peripheral device configured to scan a document, a memory accessible by the multi-function peripheral device and configured to store the scanned document, a printing device configured to access the memory and having a virtual keypad for a user to enter access information before the scanned document is printed, and a network connecting the multi-function peripheral device to the printing device.

Another aspect is a multi-function peripheral device configured to scan and send a document. The multi-function peripheral device comprises a scanner configured to scan a document, a controller configured to send the scanned document to a predetermined destination printer, and a control panel configured to receive access information from a user, wherein the access information is transmitted to the predetermined destination printer.

Yet another aspect is a method of securely sending scanned documents on a networked system. The method comprises scanning at least one print job on a multi-function peripheral device, selecting a destination printer to receive the at least one print job, entering access information associated with the at least one print job, and conveying the access information to the destination printer.

Another aspect is a multi-function peripheral device configured with software to execute the functions of scanning at least one print job on a multi-function peripheral device, selecting a destination printer to receive the at least one print job, entering access information associated with the at least one print job, and conveying the access information to the destination printer.

### BRIEF DESCRIPTION OF THE DRAWINGS

FIG. 1 is a diagram showing an exemplary embodiment of a server computer and a multi-function peripheral having a scanner.

FIG. 2 is a diagram showing a system configured to receive a scanned document at the multi-function peripheral of FIG. 1 and securely print the scanned document at one or more remote locations.

FIG. 3 is a flowchart of one method for scanning and sending a print job which may be performed by the system of FIG. 2.

FIG. 4 is a flowchart of one method for scanning and sending a print job which may be performed by the system of FIG. 2 without the need for server software.

FIG. 5 is a flowchart of one method for retrieving and securely printing a print job which may be performed by the system of FIG. 2.

### DETAILED DESCRIPTION OF CERTAIN EMBODIMENTS

The following description and the accompanying figures, which describe and show certain embodiments, are made to demonstrate several possible configurations that a printing system can take to include various aspects and features of the invention. The illustrations of the systems and methods are not intended to limit the disclosed aspects and features of the invention to the specified embodiments. Those of skill in the art will recognize that the disclosed aspects and features of the invention are not limited to any particular embodiment of a printing system.

In certain embodiments of the invention, the user sends a scan job to a destination printer or a group of destination printers from a multi-function peripheral device. Software is utilized to convert the scanned print job into a language that is readable by the destination printer. The software is located on the printer network. In certain embodiments, the software is located at a server computer on the network. In certain other embodiments, the software is located on the multi-function peripheral device. The destination printer or group of destination printers stores the job until the user retrieves the stored job from the destination printer or group of destination printers. Advantageously, the user may access the server software once for a group of printers should the user intend for the job to print on multiple printers. In certain embodiments, the user secures the stored job by assigning a user ID and PIN. Once the user retrieves the print job at the destination printer, the user decides if the destination printer will continue to store the print job or delete the print job.

In a network computing environment, printers are often shared among a plurality of users. Different users with physical access to the same printer may have different needs, positions, or levels of security. Therefore, it may be desirable to limit a user's access to confidential documents printed in a shared printer. Further, many different types of devices are often networked together in office settings today.

Disclosed is a method and system for securely printing documents on a networked system. The method includes scanning at least one print job on a multi-function peripheral device, sending the at least one print job to at least one printer or to at least one group of printers, storing the at least one print job in a queue, and identifying the at least one print job at the at least one printer. The method can be accomplished either with a job code, identification code, a personal identification number, or the like being entered at the site of the at least one printer. The printer then obtains and prints the at least one job associated with the code from the queue.

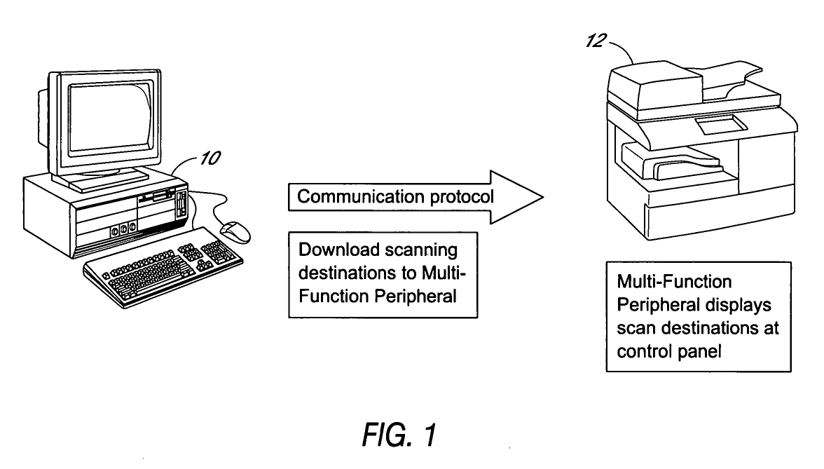

FIG. 1 is a diagram showing an exemplary embodiment of a server computer 10 and a multi-function peripheral (MFP) device 12 having a scanner. The server computer 10 may operate using one or more operating systems including, by way of example, Microsoft Windows, Windows 98, Me, 2000, XP, Linux, Red Hat, Caldera, Debian, Mandrake, Slackware, TurboLinux, and SuSE. The server computer 10 is configured to download communication protocols associated with one or more destination printers to the multi-function peripheral device 12. Once downloaded, a user of the multi-function peripheral device 12 selects one or more of the destination printers for printing the scanned document. In certain embodiments, the user selects one or more groups of destination printers. Each group of destination printers includes at least two destination printers. A destination printer may be assigned to one or more groups of destination printers.

In certain embodiments, a user creates a destination printer or a list of a group of destination printers at the server computer 10. Advantageously, the user may access the server computer 10 once to create a group of printers should the user intend for the document to print on multiple printers. In certain embodiments, the user creates the list for the group of printers at the multi-function peripheral device 10. The multi-function peripheral device 12 communicates with software residing on the server computer 10 to download the created lists. The software gives users the ability to create one or more groups of printers which the user can select as destinations at the multi-function peripheral device 12. For example in one embodiment, the user selects one or more printer devices by entering an internet protocol (IP) address or hostname associated with the selected printer device. The selected destination printers may be assigned to a group 1, for example. In another embodiment, the server computer 10 compiles a list of printer devices by polling the network for printers. In still another embodiment, the server computer 10 determines the list of printers based at least in part on a Windows Printer Driver list.

The selected printer device, group of destination printers, or destination printer is preferably supported by one or more printer languages. That is, the multi-function peripheral device 12 is able to transmit the scanned document in a printer language that is compatible with the destination printer(s).

The multi-function peripheral device 12 displays the list of destination printers or groups of destination printers obtained from the server computer 10. The user selects one or more destination printers or one or more groups of destination printers from the displayed list. In certain embodiments, the multi-function peripheral device 12 may display the supported printer devices at a control panel for the multi-function peripheral device 12. In such embodiments, the user selects the destination printers from the displayed list.

In certain embodiments, the software is embedded in the multi-function peripheral device 12 and not in the server 10. In this embodiment, the multi-function peripheral device 12 is configured to create printer and groups of printer destinations. A control panel on the multi-function peripheral device 12 allows a user to interface with the embedded software in creating the list of destination printers. For example the user may enter the IP or hostname of the printer(s) at the control panel of the multi-function peripheral device 12, select from a list of printers provided by the multi-function peripheral device 12 through polling the network 20, use other methods known to a skilled technologist for detecting available printers, or select the printers using a remote device management software tool. An exemplary remote device management software tool is Samsung's WebSyncThru and Hewlett Packard's WebjetAdmin.

In certain embodiments, the multi-function peripheral 12 device is a single device configured to perform multiple functions. These functions may include scanning, copying, printing, faxing, and the like. In this way, the multi-function peripheral 12 device is an all-in-one type of device. The multi-function peripheral 12 may print in black and white or in color. In certain embodiments, the multi-function peripheral 12 scans in color and prints in black and white. In certain embodiments, the multi-function peripheral device 12 includes a platen and a controller that controls the operation of the multi-function peripheral device 12. The details of the inner workings of scanning/printing devices are various and well known so they will not be further described.

As explained fully below, a code associated with the scanned document is used to send and receive information for a variety of purposes. In certain embodiments, users use codes with their documents to increase security, send the document to multiple printers, send the document to a group of printers, and perform other functions. Exemplary functions include, for example, uniquely identifying a user and a print job or document.

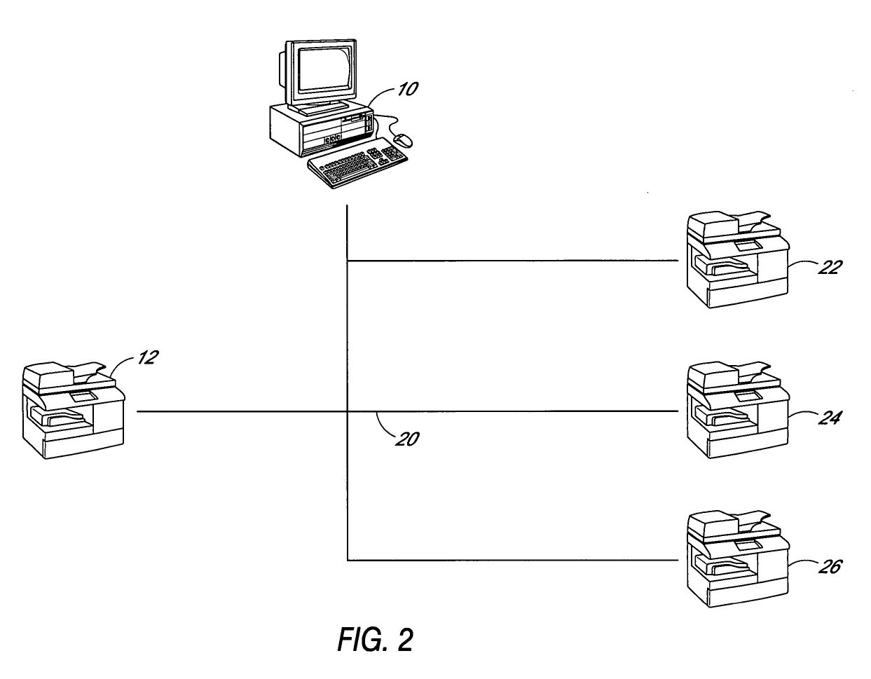

FIG. 2 is a diagram showing a printing system configured to receive a scanned document at the multi-function peripheral device 12 of FIG. 1 and securely print the scanned document at one or more destination printers 22, 24, 26. Two or more of the destination printers 22, 24, 26 may be assigned to a single group of printers. Advantageously, the user may access the printing system once to select a group of printers should the user intend for the document to print on multiple printers. A network bus 20, which may be of any type known in the art, such as Ethernet or Token-Ring, interconnects a number of computers and peripherals. For example, on network 20 there would typically be any number of multi-function peripheral devices 12 having scanners, servers 10, and of course printing devices 22, 24, 26. These devices communicate via one or more technologies that may include, for example, Hi-Speed USB 2.0, IEEE-1284 Parallel (Standard), 10/100 Base-TX, or 802.11b Wireless LAN.

The multi-function peripheral device 12 is a single device that serves several functions, including printing. Multi-function peripheral devices 12 perform at least two functions. The functions may include one or more of the following: printing, scanning, faxing, and photocopying. In certain embodiments, the multi-function peripheral device 12 scans and prints documents. In an embodiment, the multi-function peripheral device 12 uses laser printing technology for printing up to 22 pages per minute. In this embodiment, the multi-function peripheral device 12 has a duty cycle of up to 30,000 pgs/month, a resolution of up to 1200×1200 dpi, and a cartridge good for printing approximately 5,000 pages (5% coverage). The multi-function peripheral 12 may include a processor having a 166 MHz RISC, and memory of up to 144 MB.

The destination printers or printing devices 22, 24, 26 may have the same or different technology and characteristics for printing text or illustrations on paper. Exemplary technologies include daisy-wheel, dot-matrix, ink-jet, LCD, LED, line printer, and thermal printer. The printing devices 22, 24, 26 may further include one or more of the following characteristics including quality of type (letter, near letter, or draft), speed, impact or non-impact, graphics, and fonts. The printing devices 22, 24, 26 may utilize one or more printer languages including Printer Control Language 6 (PCL) from Hewlett Packard, IBM ProPrinter, Epson, PostScript variants (1, 2, 3), and Printer Job Language (PJL), for example.

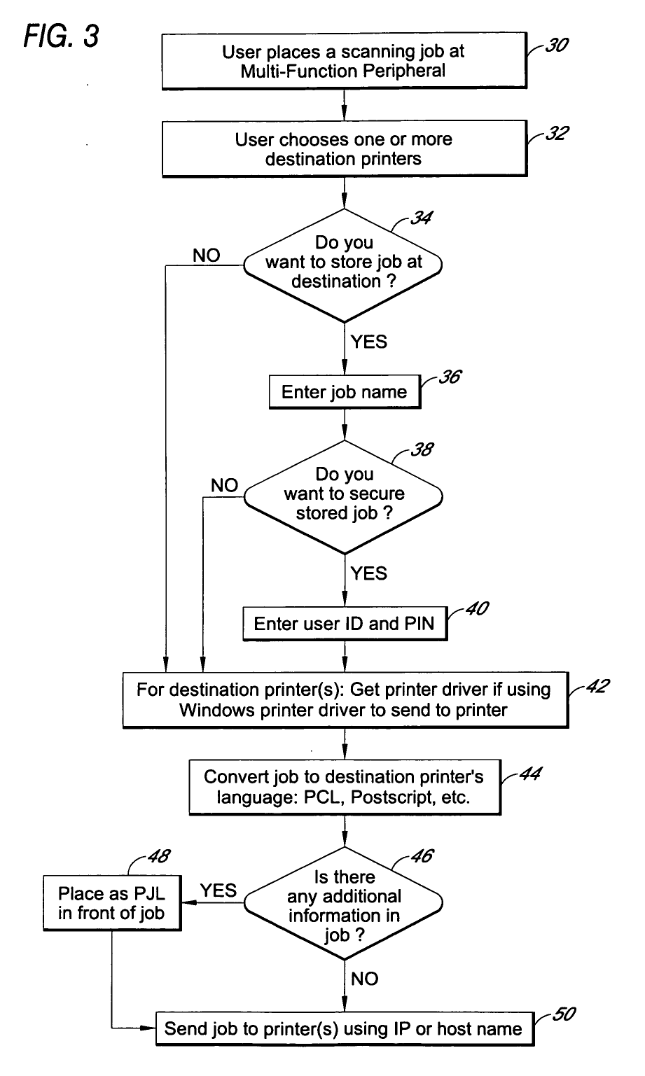

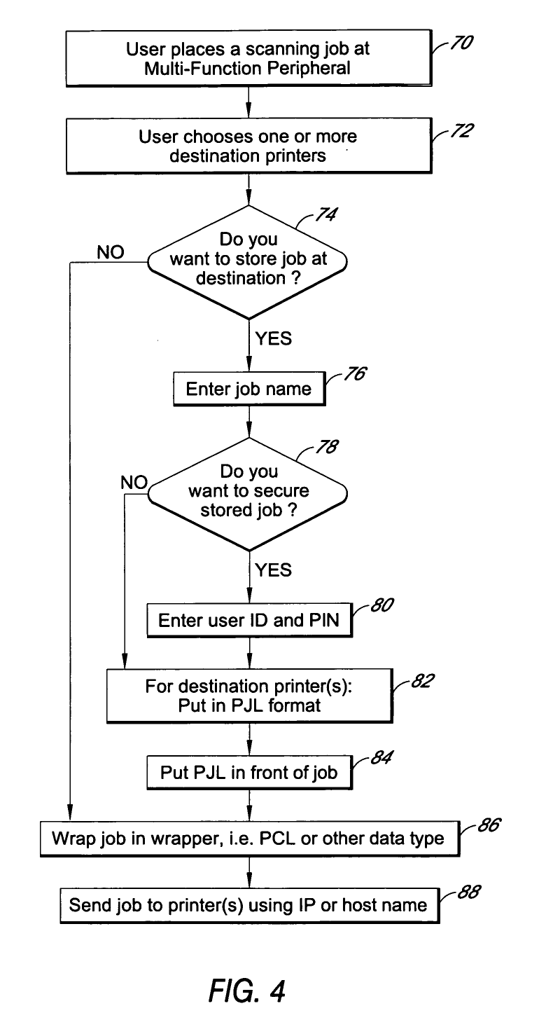

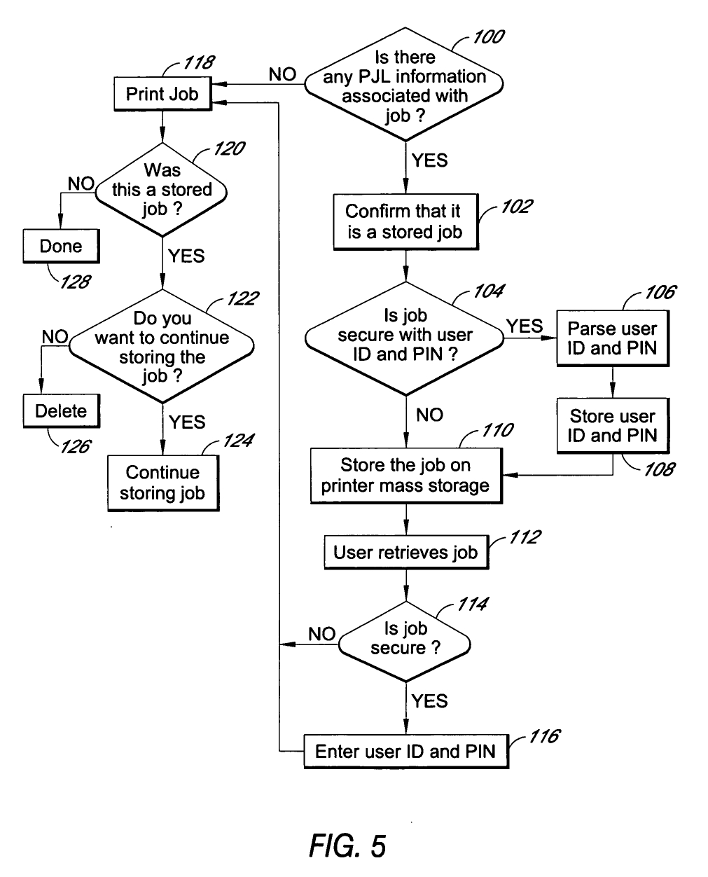

FIG. 3 illustrates an exemplary flowchart for explaining a method of scanning and sending a print job which may be performed by one embodiment of the printing system of FIG. 2. In FIG. 3, depending on circumstances, additional states may be added, others removed, or the order of the states changed. Furthermore, more than two states can be combined into one state. The same applies to FIGS. 4 and 5.

For the method described in FIG. 3, the multi-function peripheral device 12 obtains printer destinations from the server software and displays them as destination menu options at the control panel. The method begins at a state 30 where a user places a scan job at the multi-function peripheral device 12. Next, at a state 32, the user selects the destination printer or group of destination printers 22, 24, 26 as the scan job destination. Two or more of the destination printers 22, 24, 26 may be assigned to a single group of printers. Advantageously, the user may access the printing system once to select a group of printers should the user intend for the document to print on multiple printers. The process moves to a decision state 34 where the user decides whether to store the print job at one or more of the destination printers 22, 24, 26. In certain embodiments, the multi-function peripheral device 12 prompts the user with a display message asking if they want to store the job.

If the user decides to store the print job at the destination printer(s) 22, 24, 26, the process moves to a state 36 where the user enters a job name. The selected job name is associated with the print job. Moving to a decision state 38, the user decides whether to secure the stored print job at one or more of the destination printer(s) 22, 24, 26. If the user decides to secure the stored print job at the destination printer(s) 22, 24, 26, the process moves to a state 40 where the user enters a user ID and PIN.

In certain embodiments, the user ID and PIN are used to access the print job at the destination printer(s) 22, 24, 26. While various embodiments are contemplated, the term “ID” or “PIN” are generally used throughout the description to describe information that uniquely associates a print job with a user to provide secure access to other information.

In certain embodiments, the “ID” or “PIN” has one or more unique characteristics or features for controlling access to the print job at the destination printer(s) 22, 24, 26. The level of access granted would be based upon information correlated with the user's “ID” or “PIN”. In certain embodiments, the destination printers 22, 24, 26 correlate information from a combination of the “ID” or “PIN” and other sources. For example, biometric data such as voice recognition, thumbprint, retinal print, or facial data could be used together or instead of the ID and PIN. Regardless, depending upon what information the user inputs into the destination printer(s) 22, 24, 26, the destination printer(s) 22, 24, 26 grants the user access to print the print job. In certain embodiments, the destination printer(s) 22, 24, 26 allows the user to manipulate the document before printing. Manipulation may include collating, selecting the number of copies, selecting black/white v. color, cropping and other manipulations known to those having ordinary skill in the technology. The ID and PIN may also contain the user's personal printing preferences. In certain embodiments, the destination printer(s) 22, 24, 26 adjusts a variety of formatting and finishing options to the user's preferences. Exemplary preferences include paper type, font size, spacing, tabs, etc.

Once entered, the destination printer(s) 22, 24, 26 use the ID and PIN to grant user access to the print job associated with the ID and PIN. As explained above, the destination printer(s) 22, 24, 26 may allow the user to perform one or more features for printing the print job. These features include, for example, printing and manipulation, based upon what information is associated with the ID and PIN.

Differential access to destination printer(s) 22, 24, 26 functions and features serves many purposes. The simplest examples are related to security issues. For example, the ID and PIN can be used to determine whether access is granted to the print job. If access is granted, the ID and PIN can be used to determine whether access is granted to all the features of the destination printer(s) 22, 24, 26.

In certain embodiments, the user desiring access to a secure print job at the destination printer(s) 22, 24, 26 must enter an ID and PIN that matches the ID and PIN entered at the multi-function peripheral device 12. A company or other organization can control access to secure print jobs at a destination printer(s) 22, 24, 26 by granting or denying permissions to a person based upon the information entered into the destination printer(s) 22, 24, 26 or information that is associated with the entered information. For example the ID and PIN can identify a security level or a department code associated with the person assigned to such access information.

Access may be limited to particular features of a destination printer(s) 22, 24, 26. For example, access to more costly or potentially costly features could be limited. If, for example, the destination printer(s) 22, 24, 26 printing device can print in black and white as well as in color, supervisory personnel may desire to limit access to that function to only a select number of users. Those select users would have additional information associated with their access information, e.g., ID and PIN, such that they can access the color printing feature, while the other users would not.

The ID and PIN may also be used to convey information corresponding to a job, printing instructions, or even a small or limited print job to the destination printer(s) 22, 24, 26.

For example, the ID and PIN could contain information such as, for example, a fax number or numbers or a list of email addresses necessary to complete a job that a user may want. Furthermore, the image portion of the print job could originate from the multi-function peripheral device 12 while the text portion could be entered at the destination printer(s) 22, 24, 26. The ID and PIN may also be associated with information about how the owner of the destination printer(s) 22, 24, 26 will bill the user or client for using the destination printer(s) 22, 24, 26.

The ID and PIN are associated with identification information of the user. For example, most users log on to their workstations. Print jobs could be correlated to a username used at login, which would be entered into the destination printer(s) 22, 24, 26. The user may enter the login ID through a local interface connected to one of the destination printer(s) 22, 24, 26. The interface may be a virtual keyboard which is just one example of a local interface. In other embodiments, the interface may be touch screen or push button. The interface could either be integral with the destination printer(s) 22, 24, 26 or it could be a computer or input device connected by a cable or wirelessly to the destination printer(s) 22, 24, 26.

Next at a state 42, the scanned job is sent to the server computer 10. In certain embodiments, the scanned job is sent in a bitmap or other compressed format. The server computer 10 checks the printer destination(s) selected by the user to determine the correct printer language(s). For each destination printer 22, 24, 26, the server computer 10 checks for the destination printer's driver. The server computer converts the print job into the destination printer's accepted language or format. Moving to a state 44, the server computer 10 converts the scanned job to each destination printer's language. For example, the server computer converts the scanned job to PCL for destination printer 22 and Postscript for destination printer 24.

The process continues to a decision state 46 to determine if there is any additional information associated with the print job. If there is additional information associated with the print job, the process moves to a state 48 where the additional information is placed with the print job. In certain embodiments, the additional information is placed at the front of the print job. The additional information may include access information like an ID, PIN, and a flag indicated whether the job is secured on not secured. The information may be converted to the same language as the print job or to a different language or format. For example, the print job could be in PCL and the additional information associated with the print job could be in PJL.

Next at a state 50, the print job is sent to the destination printer(s) 22, 24, 26. If the user selected multiple destination printers 22, 24, 26, the user may return to state 34 for each destination printer.

Returning to decision state 46, if there is no additional information associated with the print job, the process moves to state 50 and proceeds as described above.

Returning to decision state 38, if the user does not want to secure the stored print job, the process moves to a state 42 and proceeds as described above.

Returning to a decision state 34, if the user does not want to store the print job at the destination printer(s) 22, 24, 26, the process moves to a state 42 and proceeds as described above.

FIG. 4 is a flowchart of one method for scanning and sending a print job which may be performed by the printing system of FIG. 2 without the need for a separate server storing software. For the method described in FIG. 4, the multi-function peripheral device 12 itself determines the available printer destinations and displays them as destination menu options at the control panel. In certain embodiments, the printer software is within the multi-function peripheral device 12 itself.

The method begins at a state 70 where a user places a scan job at the multi-function peripheral device 12. Next, at a state 72, the user selects the destination printer or group of destination printers 22, 24, 26 as the scan job destination. The multi-function peripheral device 12 is configured to create printer and groups of printer destinations. Two or more of the destination printers 22, 24, 26 may be assigned to a single group of printers. Advantageously, the user may access the printing system once to select a group of printers should the user intend for the document to print on multiple printers. A control panel on the multi-function peripheral device 12 allows the user to interface with the embedded software in creating the list of destination printers 22, 24, 26. For example the user may enter the IP or hostname of the printer(s) at the control panel of the multi-function peripheral device 12, select from a list of printers provided by the multi-function peripheral device 12 through polling the network 20, employ other methods known to a normally skilled technologist for detecting available printers, or select the printers using a remote device management software tool. An exemplary remote device management software tool is Samsung's WebSyncThru and HP's WebjetAdmin.

The process moves to a decision state 74 where the user decides whether to store the print job at one or more of the destination printers 22, 24, 26. In certain embodiments, the multi-function peripheral device 12 prompts the user with a display message asking if they want to store the job.

If the user decides to store the print job at the destination printer(s) 22, 24, 26, the process moves to a state 76 where the user enters a job name. The job name is associated with the print job. Moving to a decision state 78, the user decides whether to secure the print job at one or more of the destination printers 22, 24, 26. If the user decides to secure the stored print job at the destination printer(s) 22, 24, 26, the process moves to a state 80 where the user enters a user ID and PIN.

The user employs the ID and PIN to access the print job at the destination printer(s) 22, 24, 26. Depending upon what information is input into the destination printer(s) 22, 24, 26, the destination printer(s) 22, 24, 26 grant the user access to the print job. In certain embodiments, the destination printer(s) 22, 24, 26 allows a user to manipulate the document before printing. Manipulation may include collating, selecting the number of copies, selecting black/white v. color, cropping and other manipulations known to one having ordinary skill in the art.

The access information may also contain the user's personal printing preferences. In embodiments, the destination printer(s) 22, 24, 26 could adjust a variety of formatting and finishing options to the user's preferences. These options may include selecting paper type, font size, spacing, tabs, etc.

Once entered, the destination printer(s) 22, 24, 26 grants the user access to the print job associated with the entered access information. The ID and PIN may also be used to grant access to conveyed information corresponding to a job, printing instructions, or even a simple and limited print job to the destination printer(s) 22, 24, 26.

After a job is sent to the destination printer(s) 22, 24, 26, the same user who initiated the transmission may walk to the destination printer(s) 22, 24, 26. Once at the destination printer 22, 24, 26, the user enters the login information. The user may enter the login ID through a local interface connected to the destination printer 22, 24, 26. The interface may be a virtual keyboard which is just one example of a local interface. The interface may be touch screen or push button. The interface could either be integral with the destination printer(s) 22, 24, 26 or it could be a computer hardwired to the destination printer(s) 22, 24, 26.

Next at a state 82, the multi-function peripheral device 12 checks the selected printer destination(s) to determine the correct printer language(s). In certain embodiments for each destination printer 22, 24, 26, the multi-function peripheral device 12 checks for the destination printer's driver.

The process continues to a state 84 where any additional information is placed with the print job. In certain embodiments, the additional information is placed at the front of the print job. The additional information may include ID, PIN, and whether the job is a secured job. The information may be placed in the same or different printer language as the print job. For example, the print job could be in PCL and the additional information associated with the print job could be in PJL.

Moving to a state 86, the multi-function peripheral device 12 converts the scanned job in to each destination printer's language. For example, the multi-function peripheral device 12 converts the scanned job to PCL for destination printer 22 and Postscript for destination printer 24.

Next at a state 88, the print job is sent to the destination printer(s) 22, 24, 26. In certain embodiments, the print job is sent to each destination printer(s) 22, 24, 26 using an IP address or host name associated with each destination printer 22, 24, 26. If the user selected multiple destination printers 22, 24, 26, the user may return to state 74 for each destination printer.

Returning to decision state 78, if the user does not want to secure the stored print job, the process moves to a state 82 and proceeds as described above.

Returning to a decision state 74, if the user does not want to store the print job at the destination printer(s) 22, 24, 26, the process moves to a state 86 and proceeds as described above.

FIG. 5 is a flowchart of one method for retrieving and securely printing a print job which may be performed by the printing system of FIG. 2. The user may retrieve the print job at two or more of the destination printers 22, 24, 26. The two or more destination printers may be assigned to a single group of printers. Beginning at a decision state 100, the destination printer(s) 22, 24, 26 determine whether there is any additional information associated with the received print job. The additional information may include an ID, PIN, and whether the job is a secured job. In certain embodiments, the additional information is in the header of the print job. The information may be in the same or different printer language as the print job. For example, the print job could be in PCL and the additional information associated with the print job could be in PJL.

If there is additional information associated with the print job, the process moves to a state 102 where the destination printer(s) 22, 24, 26 determines if the additional information indicates that the job is a stored job.

The process moves to a decision state 104, where the destination printer(s) 22, 24, 26 determines if the additional information indicates that the job is a secured job. If the print job is a secured job, the process moves to a state 106 where the destination printer(s) 22, 24, 26 parses the access information, for instance, ID and PIN. The ID and PIN may also contain the user's personal printing preferences. In certain embodiments, the destination printer(s) 22, 24, 26 adjust a variety of formatting and finishing options to the user's preferences.

Next at a state 108, the destination printer(s) 22, 24, 26 stores the parsed user ID and PIN. Continuing to a state 110, the destination printer(s) 22, 24, 26 stores the print job in a memory. Exemplary memories include a hard drive, flash memory or any other data storage device.

Moving to a state 112, the user initiates the retrieval of the print job at the destination printer(s) 22, 24, 26. If the print job is a secure job, the process moves to a state 116 where the user enters an ID and PIN. Next at a state 118, the job is printer at the destination printer(s) 22, 24, 26.

The process moves to a decision state 120 where a determination is made as to whether the job was a stored job. If the job was a stored job, the process continues to a decision state 122 where the user decides whether the destination printer(s) 22, 24, 26 should continue to store the job after being retrieved. If the user wants to continue storing the retrieved job, the process moves to a state 124 where the destination printer(s) 22, 24, 26 continues storing the job.

Returning to decision state 122, if the user does not want the destination printer(s) 22, 24, 26 to continue storing the job, the process moves to a state 126 where the user instructs the destination printer(s) 22, 24, 26 to delete the job.

Returning to decision state 120, if the print job was not a stored job, the process concludes at a state 128.

Returning to decision state 114, if the user did not request that the print job be secure, the process moves to state 118 where the job is printed. The process then continues as described above.

Returning to decision state 104, if the user did not identify the job as a secured job, the process moves to the state 110 as described above.

Returning to decision state 100, if the destination printer(s) 22, 24, 26 determine that there is no additional information associated with the received print job, the process moves to state 118 where the job is printed. The additional information may include access information, such as ID and PIN, and whether the job is a secured job. The process then continues as described above.

Of course, it is to be understood that not necessarily all such objectives or advantages may be achieved in accordance with any particular embodiment using the printing systems and methods described herein. Thus, for example, those skilled in the technology will recognize that the systems may be developed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. Although these techniques and systems have been disclosed in the context of certain embodiments and examples, it will be understood by those skilled in the art that these techniques and systems may be extended beyond the specifically disclosed embodiments to other embodiments and/or uses and obvious modifications and equivalents thereof. Additionally, it is contemplated that various aspects and features of the invention described can be practiced separately, combined together, or substituted for one another, and that a variety of combination and sub combinations of the features and aspects can be made and still fall within the scope of the invention. Thus, it is intended that the scope of the systems disclosed herein disclosed should not be limited by the particular disclosed embodiments described above.

What is claimed is:

1. A method of securely printing scanned documents on a networked system, comprising:
scanning at least one print job on a multi-function peripheral device;
sending the at least one print job to at least one printer;
storing the at least one print job in a queue;
identifying the at least one print job at the at least one printer; and
printing the identified print job from the queue.

2. The method of claim 1, wherein the queue is kept on a memory at the at least one printer.

3. The method of claim 1, wherein the queue is kept on a memory connected to the networked system, but remote from the at least one printer.

4. The method of claim 1, wherein the at least one print job is associated with access information and further comprising conveying the access information to the at least one printer.

5. The method of claim 4 further comprising storing the access information in the queue; and
entering the access information into the at least one printer before printing the at least one print job.

6. The method of claim 4, wherein the access information comprises an identification name associated with a user.

7. The method of claim 4, wherein the access information comprises a personal identification number associated with the user.

8. The method of claim 4, wherein the access information comprises a job code associated with the at least one print job.

9. The method of claim 4 further comprising entering the access information through a user interface proximate to the multi-function peripheral device.

10. The method of claim 4 further comprising entering the access information through a user interface proximate to the at least one printer.

11. The method of claim 10, wherein entering the access information through the user interface includes entering the access information through a virtual keyboard.

12. The method of claim 1 further comprising converting the print job to a printer language.

13. The method of claim 12, wherein the printer language is PCL.

14. The method of claim 12, wherein the printer language is Postscript.

15. The method of claim 12, wherein the at least one printer is at least part of a group of printers.

16. A method of transferring documents from a first location to a second location, comprising:
scanning at least one document at a multi-function peripheral device having document transmission capabilities;
sending the scanned document to a queue;
entering access information into a printer device having access to the queue; and
obtaining the at least one job associated with the access information from the queue after entering the access information.

17. The method of claim 16, wherein the scanned document is associated with the access information and further comprising conveying the access information to the printer device.

18. The method of claim 16 further comprising storing the access information in the queue.

19. The method of claim 16 further comprising converting the scanned document to a printer language.

20. The method of claim 16, wherein the scanned document is transmitted via a wireless link.

21. The method of claim 16, wherein the scanned document is transmitted via a wired link.

22. The method of claim 21, wherein the document is transmitted through the Internet.

23. The method of claim 16 further comprising entering the access information into a second printer, wherein the printer and the second printer are at least part of a group of printers.

24. A system for securely printing a scanned document, the system comprising:
a multi-function peripheral device configured to scan a document;
a memory accessible by the multi-function peripheral device and configured to store the scanned document;
at least one printing device configured to access the memory and having a virtual keypad for a user to enter access information before the scanned document is printed; and
a network connecting the multi-function peripheral device to the at least one printing device.

25. The system of claim 24, further comprising a server storing software configured to identify a printer driver to associate with the at least one printing device.

26. A multi-function peripheral device configured to scan and send a document, the multi-function peripheral device comprising:
a scanner configured to scan a document;
a controller configured to send the scanned document to at least one predetermined destination printer; and
a control panel configured to receive access information from a user, wherein the access information is transmitted to the at least one predetermined destination printer.

27. The multi-function peripheral device of claim 26, wherein the access information is associated with the scanned document.

28. The multi-function peripheral device of claim 26 further comprising a memory configured to store at least a portion of the scanned document and at least a portion of the access information.

29. The multi-function peripheral device of claim 26, wherein the access information comprises a personal identification number associated with the user.

30. The multi-function peripheral device of claim 26, wherein the access information comprises a job code associated with the scanned document.

31. The multi-function peripheral device of claim 26, wherein the control panel comprises a virtual keyboard configured to receive the access information.

32. The multi-function peripheral device of claim 26, further comprising software configured to convert the scanned document in a printer language.

33. The multi-function peripheral device of claim 26, wherein the printer language is PCL.

34. The multi-function peripheral device of claim 26, wherein the printer language is Postscript.

35. A method of securely sending scanned documents on a networked system, comprising:
scanning at least one print job on a multi-function peripheral device;
selecting a destination printer to receive the at least one print job;
entering access information associated with the at least one print job; and
conveying the access information to the destination printer.

36. The method of claim 35 further comprising storing the at least one scanned print job.

37. The method of claim 35, wherein the access information comprises an identification name associated with a user.

38. The method of claim 35, wherein the access information comprises a personal identification number associated with a user.

39. The method of claim 35, wherein the access information comprises a job code associated with the at least one print job.

40. The method of claim 35 further comprising entering the access information through a user interface proximate to the multi-function peripheral device.

41. The method of claim 40, wherein entering the access information through the user interface includes entering the access information through a virtual keyboard.

42. The method of claim 35 further comprising converting the at least one print job to a printer language.

43. The method of claim 42, wherein the printer language is PCL.

44. The method of claim 42, wherein the printer language is Postscript.

45. The method of claim 35 further comprising:
selecting a second destination printer to receive the at least one print job; and
conveying the access information to the second destination printer.

46. The method of claim 45, wherein the destination printer and the second destination printer are at least part of a group of printers.

47. A multi-function peripheral device configured with software to execute the functions of:
scanning at least one print job on a multi-function peripheral device;
selecting a destination printer to receive the at least one print job;
entering access information associated with the at least one print job; and
conveying the access information to the destination printer.
